(19) United States
(12) Patent Application Publication
(10) Pub. No.: US 2013/0227822 A1
(43) Pub. Date: Sep. 5, 2013

(54) LOAD-BEARING APPARATUS FOR INTRODUCING LOAD FORCES, SUCH AS CABLE FORCES OR TENSIONING FORCES, FOR EXAMPLE, FROM SURFACE STRUCTURES

(71) Applicant: Helmut Rube, Sussen (DE)

(72) Inventor: Helmut Rube, Sussen (DE)

(21) Appl. No.: 13/261,644

(22) PCT Filed: Oct. 11, 2011
(86) PCT No.: PCT/EP2011/005109

§ 371 Date: Apr. 23, 2013

(30) Foreign Application Priority Data
Oct. 29, 2010 (DE) 10 2010 050 066.6

(51) Int. Cl. F16G 11/00

(52) U.S. Cl. CPC F16G 11/00
USPC 24/132 AA

(57) ABSTRACT

A load-bearing apparatus for introducing load forces, such as cable forces or tensioning forces, for example, from surface structures into supporting structures, having a tension element (2) which is connected to an anchoring element (4) of the supporting structure and with which a connection device (14) for tension members interacts, said connection device (14) being pivotable about a first pivot axis and having at least one connection wing (18) that projects laterally with respect to the tension element (2) and forms at least one connection point (22), which is offset with respect to the tension element (2), for a tension member in question, is characterized in that the at least one connection wing (18) is in abutment with the tension element (2) via an articulation arrangement such that it is pivotable about at least one further pivot axis (at 8, 46) in relation to the tension element (2).

The invention relates to a load-bearing apparatus for introducing load forces, such as cable forces or tensioning forces, for example, from surface structures, into supporting structures and that comprises a tension element, which is connected to an anchoring element of the supporting structure, and with which a connecting device for tension members interacts, said connecting device being pivotable about a first pivot axis and having at least one connecting wing that projects laterally with respect to the tension element and forms at least one connecting point, which is offset with respect to the tension element, for a tension member in question.

Modern architecture has increasingly incorporated concepts of load-bearing structures, where planar elements, such as tent-like or umbrella-like coverings that form, as a textile or membrane-like building material, part of a load-bearing structure, are anchored or erected on supporting structures, for example, steel supports. In order to achieve that the respective elements form space-creating structures of a desired architectural design, the respective suitable introduction of load forces, in particular, the tensioning or bearing cable forces, is a crucial factor. In order to avoid distortions of the desired architectural design, it is customary to anchor the sheet-like elements on a plurality of attachment points. A load-bearing apparatus that is useful for this purpose and that conforms to the genre described above is disclosed in document WO 2010/054702 A1. The load-bearing apparatus known from the prior art allows the load forces of a plurality of tension members to be introduced over a connecting device into a pertinent tie bar, which in turn is connected to a pole-like support or a part of a building by means of an anchoring element.

Depending on the structural configuration of the load-bearing structures, the tension members acting on the connecting part experience different tensioning directions as a function of the various lines of action of the effective load forces. Hence, there is the risk that in the event of corresponding force flows, the induced transverse forces act on the connecting part and put an excessive material load on the tension element, for example, in the form of a tie bar. The resulting failure of a load-bearing apparatus can lead to the collapse of the entire load-bearing structure and, therefore, presents a correspondingly high safety risk.

In light of this problem, the object of the present invention is to provide a load-bearing apparatus of the type under consideration that makes it possible to ensure an especially reliable introduction of the load forces, acting with different tensioning directions, into the support structures.

The invention achieves this object with a load-bearing apparatus having the features specified in claim 1 in its entirety.

According to the characterizing part of claim 1, an essential feature of the invention consists of the fact that the at least one connecting wing is in abutment with the tension element by way of an articulation arrangement such that it is pivotable about at least one additional pivot axis in relation to the tension element. As a result, the connecting wing has a multi-axis setting possibility in relation to the tension element, so that under load due to the tension members the connecting wing can move into a stabilized position, so that the multi-axis pivoting mobility does not generate any transverse forces at the tension element.

In preferred exemplary embodiments, the linear tension element is formed by a tensioning cable or, in particular, a tie bar.

In this case, the connecting device and with it the respective connecting wing is pivotable preferably about the axis of the tension element concerned.

This pivoting possibility is implemented in an especially advantageous manner in that a spherical body is attached to the tension element, in particular, the tie bar. In order to form an articulation node at the anchoring element of the supporting structure, this spherical body is mounted on a support surface that forms a part of the spherical cap. In addition to the rotating mobility of the connecting part about the axis of the tension element, the result is an additional ball joint that allows the tension element itself to perform pivoting motions about any axis in relation to the anchoring element.

With respect to the articulation arrangement between the tension element and the connecting device, the arrangement is configured preferably in such a way that the connecting device is pivotable about an axis that is vertical to the axis of the tension element.

In this case, the arrangement can be configured in an especially advantageous way so that the connecting device is mounted on the tension element in such a way that it is pivotable about the longitudinal axis of said tension element.

For an especially advantageous connection of a plurality of tension members with a connecting device, this connecting device can have two connecting wings, which extend away from the tension element in different directions.

In order to make the multi-axis setting possibility available to the connecting device, the arrangement can be configured to great advantage such that the connecting device is connected to the tension element by means of an articulation arrangement that enables the pivoting mobility about the longitudinal axis of the tension element and about the at least one additional pivot axis.

In such exemplary embodiments, the arrangement can be configured advantageously in such a way that the connecting part for the tension element forms a passage, which expands from the front end, which is assigned to the free end of the tension element, to the rear end in the direction of the lateral connecting wing, and that the front end of the passage has rotation surfaces that interact as part of the articulation arrangement with the rotation surfaces on a retaining body, which can be secured on the tension element. What is meant with the concept of interacting rotation surfaces is that those surfaces represent, like circular ring surfaces or spherical surface parts in the event of their mutual abutment, sliding bearing surfaces for the relative rotation motions (pivoting motions).

In this case, the arrangement can be configured to great advantage in such a way that the connecting part has two plates, which are held at a distance from each other by means of connecting wings fastened on both sides between said plates, in order to form the passage. At the front end of the passage, the two plates have circular ring surfaces, which form with an adjacent circular ring surface of the retaining body the sliding mounting for a pivoting motion with the pivot axis vertical to the longitudinal axis.

The circular arc surfaces on the connecting part can be, for example, concavely curved and on the retaining body convexly curved or vice versa.

In especially advantageous exemplary embodiments, the connecting part has a body, in which there is a passage that widens from its front end in the direction of the connecting wings and with which the lateral connecting wings are constructed in one piece, with the retaining body having a spherical surface section that forms a ball joint on the connecting part with a seat that forms a part of a spherical surface. An articulation arrangement in the manner of a ball joint enables a pivoting motion about any axis and, therefore, a free setting possibility for the connecting device in relation to the tension element.

In an alternative exemplary embodiment, two connecting wings with a common pivot axis are mounted in a pivotable manner independently of one another on the connecting device. As a result, the connecting points can be used, independently of each other, as additional setting possibilities, for the tension members in relation to the connecting device and in relation to each other, as a function of the load.

With respect to securing the retaining body on the tension element, the arrangement can be configured in such a way that the tension element forms an external thread on which a tightening nut forms an axial lock of the retaining body.

The invention is explained in detail below by means of exemplary embodiments that are shown in the drawings. These drawings show in

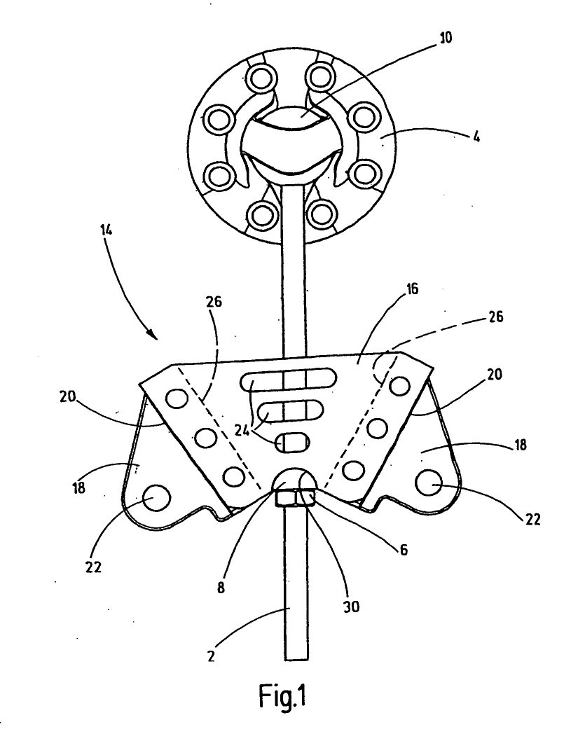

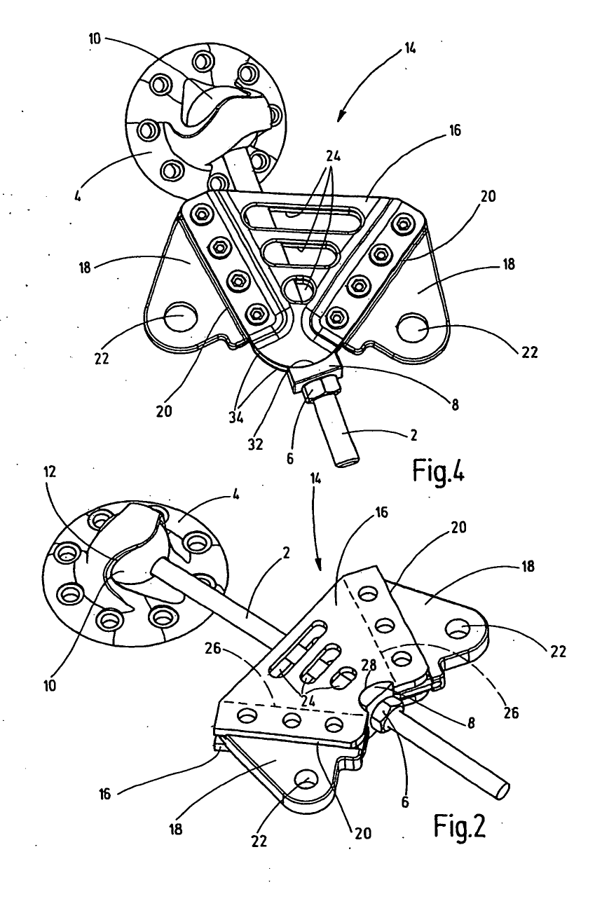

FIGS. 1 and 2 a top view and a perspective oblique view respectively of an exemplary embodiment of the load-bearing apparatus according to the invention;

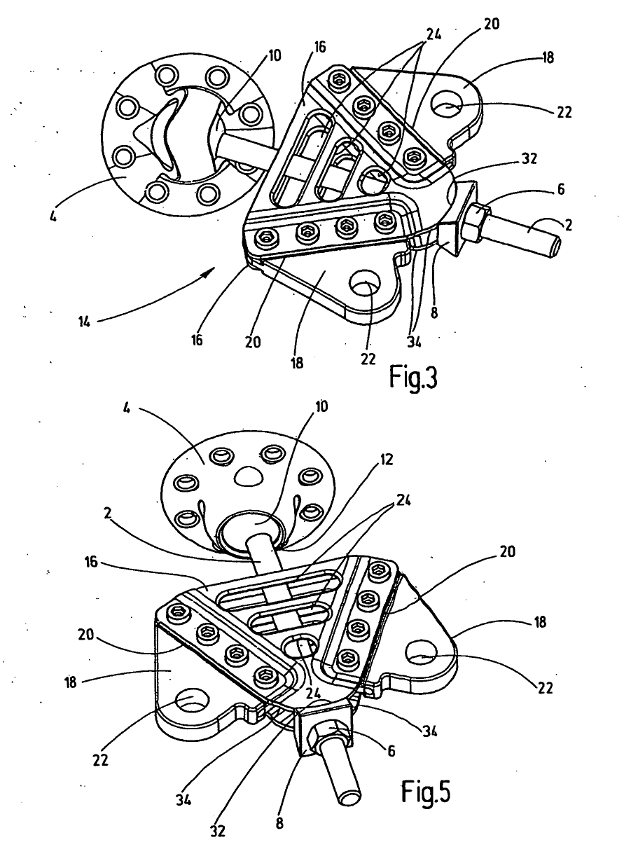

FIG. 3 a perspective oblique view of a second exemplary embodiment of the load-bearing apparatus;

FIG. 4 a perspective oblique view of an exemplary embodiment from FIG. 3, but in this case the position of the connecting device with respect to the tie bar has changed from that shown in FIG. 3;

FIG. 5 a perspective oblique view that is similar to the one shown in FIG. 3, but in this case a modified anchoring element is shown;

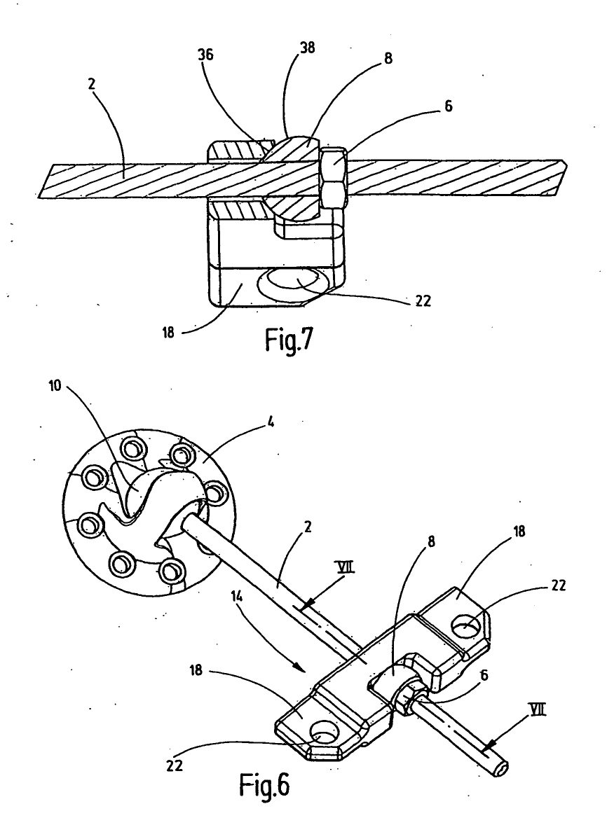

FIG. 6 a perspective oblique view of an additional exemplary embodiment of the load-bearing apparatus;

FIG. 7 a detail that is drawn to a larger scale than in FIG. 6 and corresponds to the sectional line VII-VII from FIG. 6;

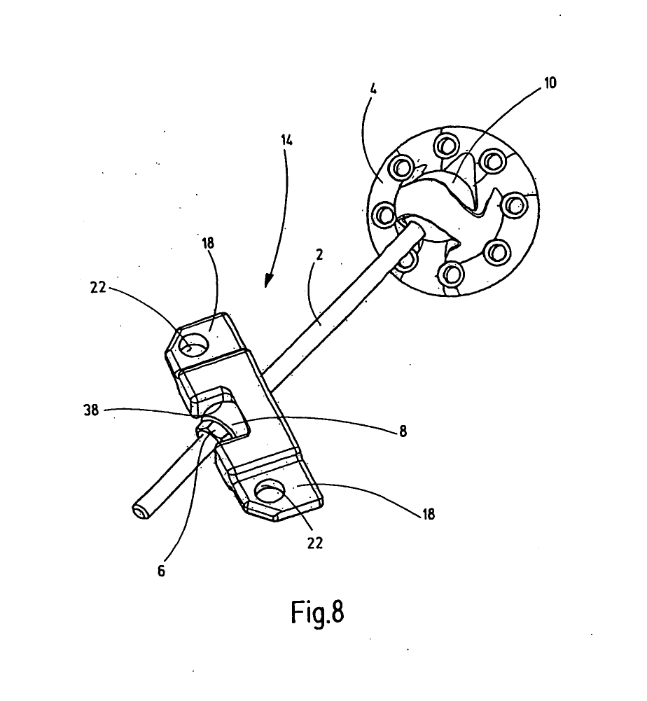

FIG. 8 a perspective oblique view that is similar to the one shown in FIG. 6, but in this case the position of the connecting device relative to the tie bar is changed;

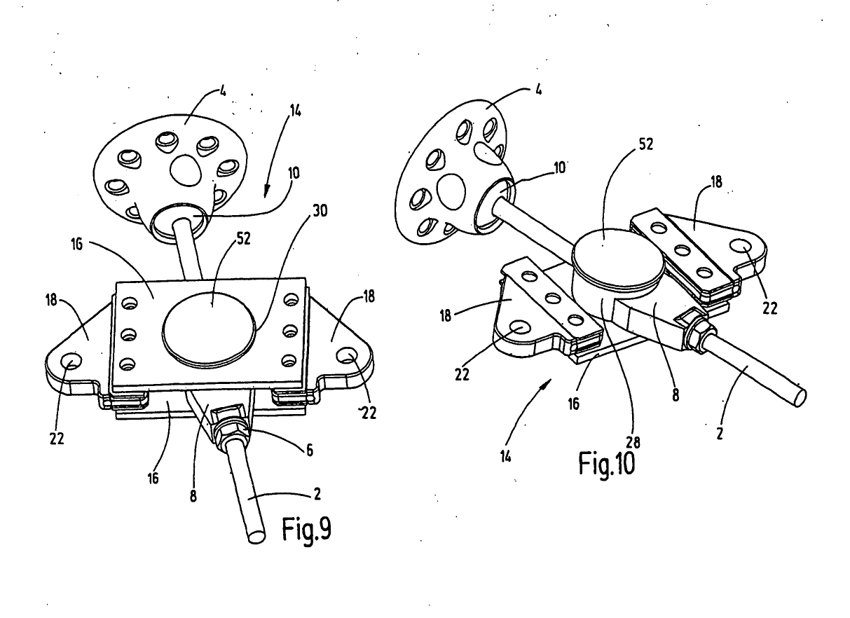

FIGS. 9 and 10 a perspective oblique view of an additional exemplary embodiment, and

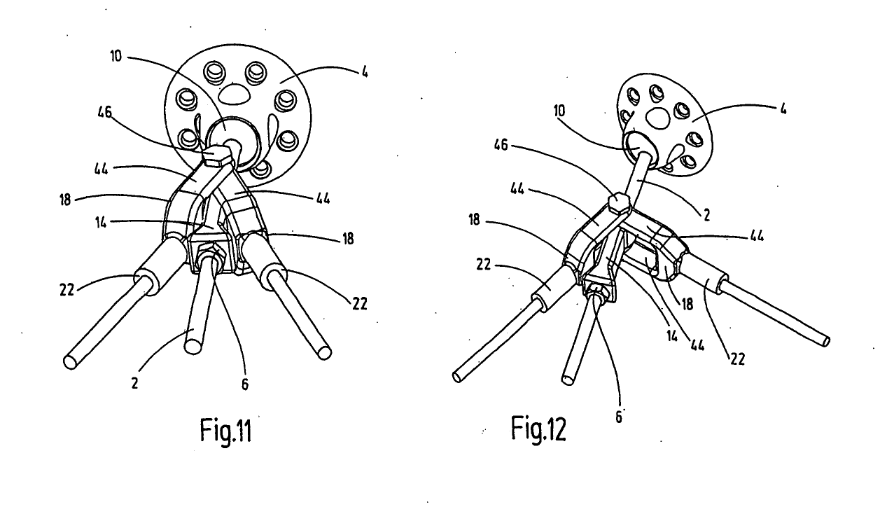

FIGS. 11 and 12 a perspective oblique view of an exemplary embodiment with connecting wings that can be pivoted relative to one another.

FIGS. 1 and 2 show a first exemplary embodiment of the load-bearing apparatus with a tie bar 2 serving as the tension element. This tie bar is connected to an anchoring element 4 that is screwed together with a supporting structure (not illustrated), for example, with the pole head of a steel support or with a building wall. The tie bar 2 has an external thread on a longitudinal region adjacent to the free end of the tie bar. On this external thread, which is not shown per se in the drawing, a tightening nut 6 secures a retaining body 8 against an axial movement toward the free end of the tie bar 2. On the other anchoring end of the tie bar 2, a spherical body 10 is attached to said tie bar. This spherical body is mounted on a support surface 12 on the anchoring element 4; and this support surface forms a part of a spherical cap, so that together with the spherical body 10 an articulation node is formed in the manner of a ball joint on the anchoring element 4.

A connecting device, which is designated as a whole as 14, is provided for introducing the load forces by way of the tie bar 2 into the anchoring element 4. This connecting device together with the tie bar 2 is arranged on the articulation node of the anchoring element 4 in such a way that it can be rotated about the longitudinal axis of the connecting device. The connecting device 14 has two identical plates 16 that are shaped, for example, in the manner of an obtuse triangle, with the blunt corner of the triangular form facing the free end of the tie bar 2. The connecting device 14 is completed with connecting wings 18, which project away from the mutually converging side edges 20 of the plates 16, and with connecting eyelets 22 for the tension members, for example, in the form of tensioning cables. The connecting wings 18 are inserted between the plates 16 and form spacers, so that an inner passage for the tie bar 2 is formed between the plates 16. This passage, which can be seen through the breakthroughs 24 in the plates 16, is defined laterally by the diverging inner edges 26 of the wings 18, so that the passage widens, as shown in the drawing, from the end, facing the retaining body 8, to the rear. As a result, the connecting device 14 can perform on the tie bar 2 a pivoting motion with the pivot axis, which is vertical to the axis of the tie bar, about the pivot center at the retaining body 8, and in particular, in addition to the rotating or pivoting motion about the axis of the tie bar 2. In order to form the corresponding pivoting center on the retaining body 8, the retaining body 8 has a convex shape in the form of a sliding surface 28, which corresponds to a circular ring section, on its surface opposite the flat engagement surface on the tightening nut 6 This sliding surface together with the concave circular ring surfaces 30 on the plates 16 forms the pivot mounting, whose axial position on the tie bar 2 can be fixed by means of the tightening nut 6.

The second exemplary embodiment, according to FIGS. 3 and 4, differs from the above-described example only in so far as, instead of the convex sliding surface 28 provided on the retaining body 8, a concave sliding surface 32 is now formed which interacts with the convex circular ring surfaces 34 on the plates 16. FIG. 4 shows the connecting device 14 in a position in which it is deflected, as compared to FIG. 3, i.e., in a position swivelled about the pivoting center on the retaining body 8.

The example from FIG. 5 corresponds to the previous example from FIGS. 3 and 4, apart from the fact that the anchoring element 4 is constructed in the form of a cup, with the inner wall of the cup forming the support surface 12 in the shape of a spherical cap; and the opening provided on the cup bottom for the tie bar 2 is dimensioned in such a way that free space for the ball joint function is made available for movements of the tie bar 2.

The additional exemplary embodiment, shown in FIGS. 6 to 8, provides a one-piece connecting device 14, inside of which there is a passage that widens laterally. It can be seen best from FIG. 7 that a spherical surface part 36 is formed on the end of the passage facing the retaining body 8 as the seat for the retaining body 8. This spherical surface part forms a ball joint in interaction with a spherical surface section 38 on the retaining body 8. Therefore, in this exemplary embodiment, the connecting device 14 has not only the ability to rotate about the axis of the tie bar 2 and to pivot vertically to this axis, but also the connecting device 14 is freely movable on the tie bar 2, save for the securing against axial motion.

FIGS. 9 and 10 show an additional exemplary embodiment in which the retaining body 8, which is axially secured on the tension element 2, has a cylindrical body 52, which extends through the passage formed between the plates 16. The cylindrical body 52 forms with its cylindrical jacket the sliding surfaces 28, which form with the circular ring surfaces 30 of the plates 16 extending through from the cylindrical body 52, the swivel mounting for the connecting device 14 with the pivot axis vertical to the axis of the tension element 2. Preferably, however, it is provided that the bolt-like cylindrical body 52 is fixed with the retaining body 8 on the tie bar 2; and the connecting wings 18 are guided around the cylindrical body 52 in such a way that they can rotate about the additional pivot axis.

The additional exemplary embodiment, shown in FIGS. 11 and 12, differs from the above-described exemplary embodiment in a specific way in that the connecting wings 18 are mounted in a pivotable manner independently of each other on the connecting device 14, so that the result is the mounting at 46 about a common pivot axis. In order to form the mounting, the connecting wings 18 have in each case a two-armed fork-type joint 44 on the connecting end.

1. Load-bearing apparatus for introducing load forces, such as cable forces or tensioning forces, for example, from surface structures into supporting structures and that comprises a tension element (2), which is connected to an anchoring element (4) of the supporting structure, and with which a connecting device (14) for tension members interacts, said connecting device being pivotable about a first pivot axis and having at least one connecting wing (18) that projects laterally with respect to the tension element (2) and forms at least one connecting point (22), which is offset with respect to the tension element (2), for a tension member in question, characterized in that the at least one connecting wing (18) is in abutment with the tension element (2) by way of an articulation arrangement such that it is pivotable about at least one additional pivot axis (at 8, 46) in relation to the tension element (2).

2. Load-bearing apparatus according to claim 1, characterized in that the tension element is formed in the manner of a line and is formed, in particular, by a tensioning cable or a tie bar (2).

3. Load-bearing apparatus according to claim 1, characterized in that the connecting device (14) is pivotable about the axis of the tension element (2).

4. Load-bearing apparatus according to claim 1, characterized in that in order to form an articulation node at the anchoring element (4) of the supporting structure, a spherical body (10), which is attached to the tension element (2), is mounted on a support surface (12) that forms a part of a spherical cap.

5. Load-bearing apparatus according to claim 1, characterized in that the connecting device (14) is pivotable about an axis (at 8) that is vertical to the axis of the tension element (2).

6. Load-bearing apparatus according to claim 1, characterized in that the connecting device (14) has two connecting wings (18), which extend away from the tension element (2) in different directions.

7. Load-bearing apparatus according to claim 1, characterized in that the connecting device (14) is connected to the tension element (2) by way of an articulation arrangement (8, 28, 30, 32, 34, 36, 38, 44, 46), which enables the pivoting mobility about the longitudinal axis of the tension element (2) and about the at least one additional pivot axis.

8. Load-bearing apparatus according to claim 4, characterized in that the connecting device (14) for the tension element (2) forms a passage, which expands from the front end, which is assigned to the free end of the tension element (2), to the rear end in the direction of the connecting wing (18), and that the front end of the passage has rotation surfaces (30, 34, 36) that interact as part of the articulation arrangement with the rotation surfaces (28, 32, 38) on a retaining body (8), which can be axially secured on the tie bar (2).

9. Load-bearing apparatus according to claim 1, characterized in that the connecting device (14) has two plates (16), which are held at a distance from each other by means of connecting wings (18) fastened on both sides between said plates, in order to form the passage; and said plates have circular ring surfaces (30, 34), which form with an adjacent circular ring surface (28, 32) of the retaining body (8) a sliding bearing for a pivoting motion with a pivot axis vertical to the longitudinal axis.

10. Load-bearing apparatus according to claim 1, characterized in that the circular ring surfaces (30, 34) on the connecting device (14) are concavely curved and on the retaining body (8) are convexly curved.

11. Load-bearing apparatus according to claim 1, characterized in that the circular ring surfaces (30, 34) on the connecting device (14) are convexly curved and on the retaining body (8) are concavely curved.

12. Load-bearing apparatus according to claim 1, characterized in that the connecting device (14) has a body, in which there is a passage that widens from its front end in the direction of the connecting wings (18) and with which the lateral connecting wings (18) are constructed in one piece; and that the retaining body (8) has a spherical surface section (38) that forms a ball joint on the connecting device (14) with a seat that forms a part of a spherical surface (36).

13. Load-bearing apparatus according to claim 1, characterized in that the two connecting wings (18) with a common pivot axis (46) are mounted in a pivotable manner independently of one another on the connecting device (14).

14. Load-bearing apparatus according to claim 1, characterized in that the tension element (2) forms an external thread, on which at least one tightening nut (6) forms an axial lock of the connecting device (14).
